(19) United States
(12) Patent Application Publication
(10) Pub. No.: US 2025/0344110 A1
(43) Pub. Date: Nov. 6, 2025

(54) NEIGHBOR CELL INFORMATION INDICATION METHOD AND APPARATUS, TERMINAL, AND NETWORK-SIDE DEVICE

(71) Applicant: VIVO MOBILE COMMUNICATION CO., LTD., Dongguan (CN)

(72) Inventor: Jiamin LIU, Dongguan (CN)

(21) Appl. No.: 19/271,806

(22) Filed: Jul. 17, 2025

Related U.S. Application Data
(63) Continuation of application No. PCT/CN2024/072596, filed on Jan. 16, 2024.

(30) Foreign Application Priority Data
Jan. 18, 2023 (CN) 202310077046.2

(51) Int. Cl. H04W 36/00

(52) U.S. Cl. CPC H04W 36/0007

(57) ABSTRACT

This application discloses a neighbor cell information indication method and apparatus, a terminal, and a network-side device. The neighbor cell information indication method in embodiments of this application includes: The terminal obtains, from first signaling of a serving cell, target information about whether a neighbor cell supports receiving a multicast service in a non-connected state.

### CROSS-REFERENCE TO RELATED APPLICATIONS

This application is a continuation of International Patent Application No. PCT/CN2024/072596, filed on Jan. 16, 2024, which claims priority to Chinese Patent Application No. 202310077046.2, filed in China on Jan. 18, 2023, both of which are incorporated herein by reference in their entirety.

### TECHNICAL FIELD

This application pertains to the field of communication technologies, and specifically relates to a neighbor cell information indication method and apparatus, a terminal, and a network-side device.

### BACKGROUND

A prior-art solution only supports receiving of a multicast (multicast) service by a terminal in a connected (Connected) state. When a large quantity of terminals are interested in the multicast service, a network-side device needs to keep the large quantity of interested terminals in a connected state.

### SUMMARY

Embodiments of this application provide a neighbor cell information indication method, to release a terminal to a non-connected state for receiving a multicast service.

According to a first aspect, a neighbor cell information indication method is provided, including:

A terminal obtains, from first signaling of a serving cell, target information about whether a neighbor cell supports receiving a multicast service in a non-connected state.

According to a second aspect, a neighbor cell information indication method is provided, including:

A network-side device sends first signaling that carries target information, where the target information is information about whether a neighbor cell of a cell controlled by the network-side device supports a terminal in receiving a multicast service in a non-connected state.

According to a third aspect, a neighbor cell information indication apparatus is provided and used in a terminal. The apparatus includes:
an information receiving module, configured to obtain, from first signaling of a serving cell, target information about whether a neighbor cell supports receiving a multicast service in a non-connected state.

According to a fourth aspect, a neighbor cell information indication apparatus is provided and used in a network-side device. The apparatus includes:
an information sending module, configured to send first signaling that carries target information, where the target information is information about whether a neighbor cell of a cell controlled by the network-side device supports a terminal in receiving a multicast service in a non-connected state.

According to a fifth aspect, a terminal is provided, including a processor and a memory. The memory stores a program or instructions capable of running on the processor, and when the program or instructions are executed by the processor, the step of the neighbor cell information indication method according to the first aspect is implemented.

According to a sixth aspect, a network-side device is provided, including a processor and a memory. The memory stores a program or instructions capable of running on the processor, and when the program or instructions are executed by the processor, the step of the neighbor cell information indication method according to the second aspect is implemented.

According to a seventh aspect, a neighbor cell information indication system is provided, including a network-side device and a terminal. The terminal is configured to perform the step of the neighbor cell information indication method according to the first aspect, and the network-side device is configured to perform the step of the neighbor cell information indication method according to the second aspect.

According to an eighth aspect, a readable storage medium is provided. A program or instructions are stored in the readable storage medium, and when the program or instructions are executed by a processor, the step of the neighbor cell information indication method according to the first aspect is implemented, or the step of the neighbor cell information indication method according to the second aspect is implemented.

According to a ninth aspect, a chip is provided. The chip includes a processor and a communication interface. The communication interface is coupled to the processor, and the processor is configured to run a program or instructions, to implement the neighbor cell information indication method according to the first aspect, or implement the neighbor cell information indication method according to the second aspect.

According to a tenth aspect, a computer program/program product is provided. The computer program/program product is stored in a storage medium, and the computer program/program product is executed by at least one processor to implement the step of the neighbor cell information indication method according to the first aspect or the second aspect.

### BRIEF DESCRIPTION OF DRAWINGS

To describe embodiments of this application more clearly, the following briefly describes the accompanying drawings required for describing embodiments. Clearly, the accompanying drawings in the following descriptions show merely some embodiments of this application, and a person of ordinary skill in the art can still derive other drawings from these accompanying drawings without creative efforts.

FIG. 1 is a block diagram of a wireless communication system applicable to an embodiment of this application;

FIG. 2 is a flowchart of a neighbor cell information indication method according to an embodiment of this application;

FIG. 3 is a flowchart of another neighbor cell information indication method according to an embodiment of this application;

FIG. 4 is a structural block diagram of a neighbor cell information indication apparatus according to an embodiment of this application;

FIG. 5 is a structural block diagram of another neighbor cell information indication apparatus according to an embodiment of this application;

FIG. 6 is a structural block diagram of a communication device according to an embodiment of this application;

FIG. 7 is a schematic diagram of a hardware structure of a terminal according to an embodiment of this application;

FIG. 8 is a structural block diagram of a terminal according to an embodiment of this application; and

FIG. 9 is a structural block diagram of a network-side device according to an embodiment of this application.

### DESCRIPTION OF EMBODIMENTS

The following clearly describes technical solutions in embodiments of this application with reference to accompanying drawings in embodiments of this application. Clearly, the described embodiments are merely a part rather than all of the embodiments of this application. All other embodiments obtained by a person of ordinary skill in the art based on embodiments of this application shall fall within the protection scope of this application.

Terms “first”, “second”, and the like in the specification and claims of this application are used to distinguish between similar objects instead of describing a specified order or sequence. It should be understood that, terms used in this way can be interchangeable under appropriate circumstances, so that embodiments of this application can be implemented in an order other than that illustrated or described herein. Moreover, the terms “first” and “second” typically distinguish between objects of one category rather than limiting a quantity of objects. For example, there can be one or more first objects. In addition, in the specification and claims, “and/or” represents at least one of connected objects, and the character “/” generally represents an “or” relationship between associated objects.

It should be noted that, a technology described in embodiments of this application is not limited to a long term evolution (Long Term Evolution, LTE)/LTE-advanced (LTE-Advanced, LTE-A) system, and can be further used in other wireless communication systems, such as a code division multiple access (Code Division Multiple Access, CDMA) system, a time division multiple access (Time Division Multiple Access, TDMA) system, a frequency division multiple access (Frequency Division Multiple Access, FDMA) system, an orthogonal frequency division multiple access (Orthogonal Frequency Division Multiple Access, OFDMA) system, a single-carrier frequency division multiple access (Single-carrier Frequency Division Multiple Access, SC-FDMA) system, and another system. Terms “system” and “network” are often used interchangeably in embodiments of this application. The described technology can be used for the systems and radio technologies described above, as well as other systems and radio technologies.

The following describes a new radio (New Radio, NR) system for illustrative purposes, and NR terms are used in most of the following descriptions. However, these technologies are also applicable to applications other than NR system applications, for example, a 6^{th} generation (6^{th} Generation, 6G) communication system.

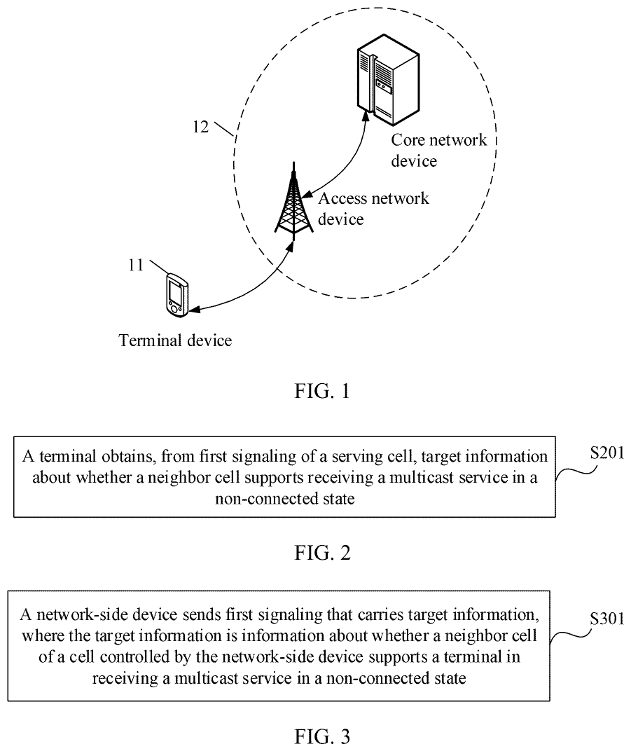

FIG. 1 is a block diagram of a wireless communication system applicable to an

embodiment of this application. The wireless communication system includes a terminal device 11 and a network-side device 12. The terminal device 11 can be a mobile phone, a tablet personal computer (Tablet Personal Computer), a laptop computer (Laptop Computer) or referred to as a notebook computer, a personal digital assistant (Personal Digital Assistant, PDA), a palmtop computer, a netbook, an ultra-mobile personal computer (ultra-mobile personal computer, UMPC), a mobile internet device (Mobile Internet Device, MID), an augmented reality (augmented reality, AR)/virtual reality (virtual reality, VR) device, a robot, a wearable device (Wearable Device), vehicle user equipment (Vehicle User Equipment, VUE), pedestrian user equipment (Pedestrian User Equipment, PUE), a smart home (a home device with a wireless communication function, like a refrigerator, a television, a laundry machine, or a furniture), a gaming console, a personal computer (personal computer, PC), a teller machine, a self-service machine, or another terminal-side device. The wearable device includes a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. It should be noted that a specific type of the terminal device 11 is not limited in embodiments of this application. The network-side device 12 can include an access network device or a core network device. The access network device 12 can also be referred to as a radio access network device, a radio access network (Radio Access Network, RAN), a radio access network function, or a radio access network unit. The access network device can include a base station, a wireless local area network (Wireless Local Area Network, WLAN) access point, a wireless fidelity (Wireless Fidelity, WiFi) node, or the like. The base station can be referred to as a node B, an evolved node B (eNB), an access point, a base transceiver station (Base Transceiver Station, BTS), a radio base station, a radio transceiver, a basic service set (Basic Service Set, BSS), an extended service set (Extended Service Set, ESS), a home node B, a home evolved node B, a transmitting receiving point (Transmitting Receiving Point, TRP), or another proper term in the field. The base station is not limited to a specific technical term, provided that the same technical effect is achieved. It should be noted that, in this embodiment of this application, a description is provided only by using a base station in an NR system as an example, and a specific type of the base station is not limited. The core network device can include but is not limited to at least one of the following: a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rules function (Policy and Charging Rules Function, PCRF) unit, an edge application server discovery function (Edge Application Server Discovery Function, EASDF), unified data management (Unified Data Management, UDM), a unified data repository (Unified Data Repository, UDR), a home subscriber server (Home Subscriber Server, HSS), a centralized network configuration (Centralized network configuration, CNC), a network repository function (Network Repository Function, NRF), a network exposure function (Network Exposure Function, NEF), a local NEF (Local NEF or L-NEF), a binding support function (Binding Support Function, BSF), an application function (Application Function, AF), and the like. It should be noted that in embodiments of this application, only a core network device in the NR system is used as an example for description, and a specific type of the core network device is not limited.

In long term evolution (Long Term Evolution, LTE) broadcast and multicast transmission, multimedia broadcast multicast service (Multimedia Broadcast Multicast Service, MBMS) service sending in multicast (or groupcast) single frequency network (Multicast Broadcast Single Frequency Network, MBSFN) mode and multicast service sending in single cell-point to multipoint (Single cell-Point to Multipoint, Sc-PtM) mode are supported. In an MBSFN manner, cells in a same MBSFN area synchronously send a same broadcast service, so that a terminal can receive the same broadcast service. Control information (control channel parameters, service channel parameters, scheduling information, and the like) and data information of an MBMS service are sent in a broadcast manner, so that both an idle (idle) terminal and a connected terminal can receive the MBMS service.

Sc-PtM is a multicast sending manner standardized after the MBMS service. A largest difference from the MBSFN manner is that scheduling and sending are performed only in a single cell in the Sc-PtM, and service scheduling is performed by using a group-radio network temporary identifier (group-Radio Network Temporary Identity, g-RNTI). In a broadcast message, scheduling information such as a broadcast control channel parameter, a service identifier, and periodic information is notified through a physical downlink control channel (Physical Downlink Control Channel, PDCCH) scrambled by the g-RNTI, and data is sent in a multicast manner, which is equivalent to that an interested terminal listens to the g-RNTI to obtain data scheduling and then perform receiving.

When receiving a new radio broadcast (New Radio broadcast, NR broadcast) service in an R17 version, a network carries, in a system information block (System Information Block, SIB) and a multicast/broadcast service control channel (Multicast/Broadcast Services Control Channel, MCCH), indication information indicating whether a neighbor cell supports a broadcast service. When performing a cell reselection and reselecting a target cell, a terminal in a non-connected state determines, based on whether the target cell supports a service that the terminal is interested in, whether to continue receiving the broadcast service by reading the MCCH or by initiating unicast establishment.

Because an R17 NR multicast service only supports receiving of a terminal in a radio resource control connected (Radio Resource Control CONNECTED, RRC CONNECTED) state, there is no non-connected mobility problem. The terminal in the connected state is handed over during moving. Interaction between a source cell and the target cell is used by the terminal to ensure that the target cell supports receiving of a multicast service in a proper manner, and a configuration of the target cell is sent to UE by using dedicated signaling.

Currently, a prior-art solution only supports the terminal in the connected state in receiving the multicast service. When a large quantity of UEs are interested in the multicast service, a network-side device needs to keep the large quantity of interested terminals in a connected state. This results in a large quantity of extra overheads for control and management, and is not conducive to overall network efficiency. Therefore, releasing a terminal to a non-connected state for receiving the multicast service is a compromise solution that ensures both receiving effects and network overheads, to improve overall network efficiency. However, after the terminal is released to the non-connected state for receiving the multicast service, a problem of how to continuously perform multicast service receiving when UE moves needs to be considered.

In a related technology, because the R17 NR multicast service only supports receiving by the terminal in the connected state, when the terminal moves, service continuity during handover of the terminal to the target cell is ensured by using an inter-interface message and dedicated signaling. However, the neighbor cell indication information of the R17 NR broadcast service cannot be directly reused to the multicast service, because receiving of the multicast service is more complex than receiving of the broadcast service, for example, the target cell can only support the terminal in the connected state in receiving the multicast service, or can support the terminal in the non-connection status in receiving the multicast service, or may not support the multicast service.

To resolve the problem in the related technology, this application provides a neighbor cell information indication method, to implement an information indication of a neighbor cell of a terminal that receives a multicast service in a non-connected state, so that the terminal can obtain related information about the neighbor cell in time when receiving the multicast service in the non-connected state, and then can continuously receive the multicast service in time when reselecting a target cell. This ensures experience of receiving the multicast service by the terminal and reduces overall network overheads.

According to a first aspect, FIG. 2 is a flowchart of a neighbor cell information indication method according to an embodiment of this application, and the method can include the following step:

Step S201: A terminal obtains, from first signaling of a serving cell, target information about whether a neighbor cell supports receiving a multicast service in a non-connected state.

The non-connected state can include at least one of an idle state or an inactive state, and the first signaling can be common signaling such as SIB signaling or MCCH signaling.

During specific implementation, by obtaining the target information from the first signaling of the serving cell, the terminal can obtain, in time, a support status of receiving the multicast service in the non-connected state by the related neighbor cell, so that the terminal can reselect, based on the target information, a proper target cell (for example, select a target cell that supports receiving the multicast service in the non-connected state), or can select, in time, a proper manner of reselecting a target cell (for example, for a target cell that supports only receiving the multicast service in a connected state, the terminal can switch to the connected state in time to receive the multicast service), to ensure receiving continuity of the multicast service, and improve experience and system efficiency of the terminal on a basis of ensuring receiving effects.

It can be learned from the foregoing step that, an information indication of the neighbor cell that receives the multicast service in the non-connected state is implemented by using the first signaling, so that the terminal can obtain related information about the neighbor cell in time when receiving the multicast service in the non-connected state, and then can continuously receive the multicast service in time when reselecting the target cell. This ensures receiving effects and network overheads, and improves overall network efficiency.

### Implementation 1

This implementation describes an example of transmitting the first signaling that carries the target information.

Case 1: A network-side device sends the first signaling that carries the target information, and the terminal obtains, from the first signaling of the serving cell, the target information about whether the neighbor cell supports receiving the multicast service in the non-connected state.

In this embodiment, the network-side device sends, by using a first instruction based a support status of receiving the multicast service in the non-connected state by a neighbor cell of each cell controlled by the network-side device, information about whether the neighbor cell of the cell controlled by the network-side device supports the terminal in receiving the multicast service in the non-connected state.

Each cell controlled by the network-side device can be a cell that supports receiving the multicast service in the non-connected state, or can be a cell that does not support receiving the multicast service in the non-connected state. It can be understood that, in a case that the controlled cell does not support receiving the multicast service in the non-connected state, if the cell has at least one neighbor cell that supports receiving the multicast service in the non-connected state, the network-side device can indicate, by using the first signaling, target information about whether the neighbor cell of the cell supports receiving the multicast service in the non-connected state, so that the terminal of the cell can reselect a proper target cell based on the target information, and/or can select, in time, a proper manner of reselecting a target cell, to resolve a mobility problem of the terminal receiving the multicast service in the non-connected state.

Optionally, the target information carried in the first signaling includes first information and/or second information, the first information indicates a neighbor cell that supports receiving a multicast service in a non-connected state; and the second information indicates information about a multicast service that each neighbor cell supports to receive in a non-connected state.

It should be noted that a cell can be classified into three types based on whether and how to support the multicast service:

Type 1: The terminal is only supported in receiving the multicast service in the connected state, and a multicast/broadcast service radio bearer (Multicast/Broadcast Service Radio Bearer, MRB) configuration is scheduled in a point to multipoint (Point To Multipoint, PTM)/G-RNTI multicast manner.

Type 2: The terminal is supported in receiving the multicast service in the non-connected state, and the MRB configuration is scheduled in the PTM/G-RNTI multicast manner.

Type 3: Multicast scheduling is not supported, and multicast service transmission can be provided for the terminal in a unicast (for example, unicast (unicast)/data radio bearer (Data Radio Bearer, DRB)/cell-radio network temporary identifier (Cell-RadioNetwork TemporaryIdentifier, C-RNTI)) manner.

According to the foregoing classification manner, the network-side device can indicate, at cell granularity by using the first information, a support status of receiving the multicast service in the non-connected state by the neighbor cell. For example, if all multicast services in a cell are sent in a type-1 manner (that is, in a connected-state transmission manner), the cell is a type-1 cell. If at least one multicast service in a cell is sent in a type-2 manner (that is, in a non-connected transmission manner), the cell can be a type-2 cell. If all multicast services in a cell are sent in a type-3 manner (that is, in a unicast transmission manner), the cell is a type-3 cell. In this case, the network-side device can indicate, by using the first information, a neighbor cell that is a type-2 cell in a neighbor cell of any cell controlled by the network-side device.

The foregoing neighbor cell information indication manner is for all multicast services in a cell and has low granularity. Therefore, the network-side device can also use a specific multicast service as granularity, and indicate, by using the second information, a support status of receiving the specific multicast service in the non-connected state by each neighbor cell. For example, if the specific multicast service is sent in the type-1 manner in a cell, the cell is a type-1 cell for this multicast service; if the multicast service is sent in the type-2 manner in a cell, the cell is a type-2 cell for this multicast service; and if the multicast service is sent in the type-3 manner in a cell, the cell is a type-3 cell for this multicast service. In this case, the network-side device can use the second information to indicate a neighbor cell that is a type-2 cell relative to any related multicast service (for example, a multicast service that the terminal has joined in a controlled cell). It can be learned that this neighbor cell information indication manner is for a single multicast service and has higher granularity. The multicast service that the terminal has joined refers to a multicast service that is successfully joined by the terminal (that is, the network-side device authorizes the terminal to receive the multicast service) and that is maintained in a joined state.

Generally, when all multicast services or multicast services that the terminal is interested in (wants to receive) in a cell are sent in the type-1 manner or the type-3 manner, that is, when the terminal in the cell needs to receive the multicast service in the connected state, mobility of the related terminal before and after a cell reselection is completely controlled by a source cell and a target cell, service continuity can be ensured by using interface signaling and dedicated signaling, and no additional mechanism is required.

Only when at least one multicast service in a cell is sent in the type-2 manner, that is, when a terminal that can receive a multicast service in a non-connected state exists in the cell, mobility of this part of terminals follows a mobility criterion of a non-connected terminal, and the terminal independently performs a cell selection and reselection and is not controlled by a network. Therefore, multicast service continuity caused by mobility of this part of terminals is a key scenario addressed in this solution.

When the multicast service supports receiving by the non-connected terminal, configurations and configuration updates related to the multicast service can be sent by using common signaling, for example, sent by using a combination of a SIB and an MCCH. In this case, the target information about whether the neighbor cell supports receiving the multicast service in the non-connected state can be carried in the SIB signaling and/or the MCCH signaling. A terminal that has joined the multicast service (or is interested in the multicast service and has joined the multicast service) reads the target information from the SIB signaling and/or the MCCH signaling in the non-connected state and performs a corresponding operation (for example, a cell reselection, or switching a multicast service receiving status), to ensure continuity of the multicast service of the terminal.

In a possible implementation, it is considered that the SIB signaling carries information about MCCH scheduling (for example, a scheduling cycle), and the terminal generally reads the SIB signaling first, and then finds related MCCH signaling based on the SIB signaling. Therefore, compared with the MCCH signaling, the SIB signaling is generally used to carry coarse-grained information. Therefore, the SIB signaling can be used to carry the first information at cell granularity. The MCCH signaling can be used to carry fine-grained information. Therefore, the MCCH signaling can be flexibly used to carry the first information at cell granularity and/or the second information at specific multicast service granularity.

Optionally, the first information carried in the first signaling (namely, the SIB signaling and/or the MCCH signaling) can be a first cell ID list or a first cell index list.

The first cell ID list includes IDs that are carried in the first signaling and that indicate neighbor cells that support receiving at least one multicast service in a non-connected state, and the ID of the neighbor cell can be a new radio cell global identifier identity document (New Radio Cell Global Identifier Identity Document, NCGI ID).

The first cell index list is position or sorting information of neighbor cells that are in a cell ID list carried in other signaling (for example, common signaling other than the SIB signaling and/or the MCCH signaling) and that support receiving at least one multicast service in a non-connected state. For example, the first cell index list can include three index values 0, 1, and 2. This indicates that in the cell ID list that is carried in other signaling and that is associated with the first cell index list, cells corresponding to the first three IDs are neighbor cells that support receiving at least one multicast service in a non-connected state.

Optionally, the second information carried in the MCCH signaling can be a second cell ID list or a second cell index list corresponding to each multicast service (for example, service description information such as a temporary mobile group identity (Temporary Mobile Group Identity, TMGI) of the multicast service).

The second cell ID list corresponding to each multicast service includes IDs of neighbor cells that support receiving the multicast service in the non-connected state, and the ID of the neighbor cell can be an NCGI ID.

The second cell index list corresponding to each multicast service is position or sorting information of neighbor cells that are in a cell ID list carried in the first signaling or other signaling and that support receiving the multicast service in the non-connected state. For example, if the first signaling or other signaling has indicated a neighbor cell ID list (for example, the first cell ID list) that supports receiving a multicast service in the non-connected state, the second cell index list can include three index values 0, 1, and 2, indicating that in the first cell ID list, neighbor cells corresponding to the first three IDs are neighbor cells that support receiving the multicast service in the non-connected state. Alternatively, bits can be used to identify neighbor cells that support receiving the multicast service in the non-connected state. For example, the second cell index list can include bits “11100000”, the first three bits 1 indicate that the first three cell IDs in the corresponding neighbor cell ID list correspond to neighbor cells that support receiving the multicast service in the non-connected state, and the last five bits 0 indicate that the last five cell IDs in the neighbor cell ID list are neighbor cells that do not support receiving the multicast service in the non-connected state.

Case 2: When the support status of receiving the multicast service in the non-connected state by the neighbor cell changes, the network-side device updates the target information and sends first signaling that carries updated target information. The terminal receives changed first signaling of the serving cell, where the changed first signaling of the serving cell is generated in a case that the information about whether the neighbor cell supports receiving the multicast service in the non-connected state changes. The terminal re-obtains, from the changed first signaling of the serving cell, the target information about whether the neighbor cell supports receiving the multicast service in the non-connected state.

In this embodiment, if the support status of the neighbor cell changes, the network-side device can perform an update operation on corresponding target information by using a SIB update or MCCH update process, so that an interested terminal can read updated corresponding target information in time after being notified of a SIB update or an MCCH update.

In Implementation 1, the network-side device can update the target information in time, and can enable the terminal to obtain information related to the neighbor cell in time by using target information carried in the SIB signaling (namely, information about the neighbor cell that supports receiving the multicast service in the non-connected state) and/or target information carried in the MCCH signaling (namely, information about the neighbor cell that supports receiving the multicast service in the non-connected state and/or specific information about whether neighbor cells support receiving each multicast service in the non-connected state), so that a proper target cell is reselected during a cell reselection, and/or a proper manner of reselecting a target cell can be selected in time, to ensure continuity of receiving the multicast service. This improves terminal experience and system efficiency on a basis of ensuring receiving effects of the terminal.

### Implementation 2

This implementation describes an example of how the terminal determines a target cell before accessing the target cell and receiving, from the target cell, a multicast service that the terminal has joined.

Case 1: The terminal determines the target cell based on the target information when a trigger condition of a cell selection and/or reselection mechanism is met.

It can be understood that mobility management is a necessary mechanism for a cellular mobile communication system, and can assist in implementing load balancing and improving user experience and overall system performance. In NR, mobility management is classified into two types: mobility management in a non-connected state and mobility management in a connected state. Mobility management in the connected state is mainly implemented by cell handover, which is completely controlled by the network-side device and assisted by the terminal for measurement. Mobility management in the non-connected state is implemented by a cell selection/reselection, which is assisted by the network-side device for configuration. During specific implementation, the terminal can use completion of a public land mobile network (Public Land Mobile Network, PLMN) selection and/or a stored (or indicated) access technology as a precondition for cell selection, and can use an R criterion as a trigger condition of a cell reselection.

Optionally, when the trigger condition of the cell selection and/or reselection mechanism is met, the terminal determines at least one candidate target cell from neighbor cells indicated by the target information; and the terminal determines, based on the at least one candidate target cell, the target cell based on at least one of the following:

A-1: The terminal determines, as the target cell, one candidate target cell that is in the at least one candidate target cell and that supports receiving, in a non-connected state, the multicast service that the terminal has joined, where in a case that the terminal has joined a plurality of multicast services, that the candidate target cell supports receiving, in the non-connected state, the multicast service that the terminal has joined means that the candidate target cell supports receiving, in the non-connected state, all the multicast services that the terminal has joined.

A-2: The terminal determines any candidate target cell in the at least one candidate target cell as the target cell in a case that each of the at least one candidate target cell does not support receiving, in a non-connected state, the multicast service that the terminal has joined.

A-3: The terminal determines, as the target cell in a case that the at least one candidate target cell partially supports receiving, in a non-connected state, the multicast service that the terminal has joined, one candidate target cell that is in the at least one candidate target cell and that supports a maximum quantity of multicast services that the terminal has joined or supports a multicast service of a highest priority.

That the candidate target cell does not support receiving, in the non-connected state, the multicast service that the terminal has joined means that the candidate target cell does not support receiving, in the non-connected state, all the multicast services that the terminal has joined; and that the candidate target cell partially supports receiving, in the non-connected state, the multicast service that the terminal has joined means that the candidate target cell supports receiving, in the non-connected state, a part of the multicast services that the terminal has joined.

For A-1, the terminal can preferentially select, as the target cell, the candidate target cell that supports receiving, in the non-connected state, all the multicast services that the terminal has joined (the terminal can join one or more multicast services). If there are a plurality of candidate target cells that support receiving, in the non-connected state, all the multicast services that the terminal has joined, the terminal can select one of the candidate target cells (for example, select a candidate target cell with best link quality) as the target cell based on implementation of the terminal.

For A-2, if no candidate target cell supports receiving, in the non-connected state, at least one multicast service that the terminal has joined, when there is only one candidate target cell, the terminal can directly use the candidate target cell as the target cell; or when there are a plurality of candidate target cells, the terminal can randomly select a candidate target cell, or select a candidate target cell based on implementation of the terminal (for example, based on link quality), and use the selected candidate target cell as the target cell.

For A-3, if there are a plurality of candidate target cells, and the plurality of candidate target cells at most only support receiving, in the non-connected state, a part of multicast services that the terminal has joined, the terminal can preferentially select a candidate target cell that supports receiving, in the non-connected state, a maximum quantity of multicast services that the terminal has joined, or the terminal can preferentially select a candidate target cell that supports receiving, in the non-connected state, a high-priority multicast service that the terminal has joined, and use the selected candidate target cell as the target cell.

Case 2: The terminal determines the target cell when the trigger condition of the cell selection and/or reselection mechanism is met.

In this embodiment, the terminal can directly determine the target cell based on rules such as a cell selection criterion and a cell reselection criterion, and then select a proper manner to receive the multicast service based on the target information when subsequently accessing the target cell.

For example, if the current multicast service of the terminal temporarily has no data or is in an inactive state (the multicast service has a lifecycle), the source cell may release the terminal to the non-connected state. In this case, if the terminal does not learn of, from the SIB signaling and/or the MCCH signaling of the source cell, the support status of receiving the multicast service in the non-connected state by the neighbor cell (that is, does not obtain the target information from the source cell), the terminal can select the target cell based on the cell reselection criterion, and then obtain, by reading the SIB signaling and the MCCH signaling related to the multicast service of the target cell, information and configurations of the multicast service that the target cell supports to receive (for example, information and configurations of the multicast service that the terminal has joined and that supports to be received in the non-connected state), so that the terminal directly maintains the non-connected state to receive the multicast service when the multicast service is activated next time. It can be understood that if the terminal obtains the target information from the source cell, the terminal can also select, as much as possible based on Case 1, the target cell that supports receiving, in the non-connected state, the multicast service that the terminal has joined, to directly obtain the configurations in the target cell in the SIB/MCCH manner, and continue to receive the multicast service in the non-connected state.

In Implementation 2, the terminal can determine a proper target cell based on the target information, to ensure continuity of receiving the multicast service. The terminal can alternatively determine a proper target cell based on the cell selection and/or reselection mechanism used by the terminal, to reduce configuration changes to the terminal.

### Implementation 3

This implementation describes an example of a manner in which the terminal accesses the target cell after determining the target cell, and the terminal receives the multicast service from the target cell.

Case 1: In a case that the terminal receives, in a non-connected state from the serving cell, the multicast service that the terminal has joined, and the target cell supports receiving, in a non-connected state, the multicast service that the terminal has joined, the terminal maintains the non-connected state to access the target cell, and the terminal receives, in the non-connected state from the target cell, the multicast service that the terminal has joined.

In this embodiment, after accessing the target cell, the terminal can obtain, by using the SIB and/or the MCCH of the target cell, configurations of the multicast service that the terminal has joined, and continue to maintain the non-connected state to receive the multicast service.

Case 2: In a case that the terminal receives, in a non-connected state from the serving cell, the multicast service that the terminal has joined, and the target cell does not support receiving, in a non-connected state, the multicast service that the terminal has joined, the terminal switches from the non-connected state to a connected state, and accesses the target cell, and the terminal receives, in the connected state from the target cell, the multicast service that the terminal has joined.

The terminal switches from the non-connected state to the connected state before or after accessing the target cell.

In this embodiment, before or after accessing the target cell, the terminal can initiate RRC status switching to switch from the non-connected state to the connected state. If the terminal enters the connected state before reselecting or accessing the target cell, which is equivalent to that the terminal enters the connected state in the source cell, interaction between the source cell and the target cell and a dedicated signaling process can be used to ensure continuity of receiving the multicast service by the terminal from the source cell to the target cell. In this manner, service continuity of the terminal is better. If the terminal enters the connected state after reselecting or accessing the target cell, which is equivalent to that the terminal enters the connected state in the target cell, after the terminal completes status switching, a dedicated signaling configuration of the target cell can be used to ensure that the terminal can re-receive the multicast service in the target cell. However, in a signaling interaction process of status switching, the terminal may not receive the multicast service sent by the source cell due to a long distance from the source cell, and cannot directly receive the multicast service from the target cell because a new configuration of the target cell has not been obtained. Consequently, a service may be interrupted, and service receiving experience is affected.

Case 3: In a case that the terminal receives, in a connected state from the serving cell, the multicast service that the terminal has joined, and the target cell does not support receiving, in a non-connected state, the multicast service that the terminal has joined, the terminal maintains the connected state, and receives, from the target cell, the multicast service that the terminal has joined.

It can be understood that, in a case that the terminal is currently receiving or interested in a multicast service and does not support receiving in a non-connected state, the terminal needs to perform a related operation based on mobility in a connected state (for example, interaction between the source cell and the target cell and a dedicated signaling process are used to ensure continuity of receiving the multicast service by the terminal from the source cell to the target cell) even if the source cell and the target cell support receiving another multicast service in a non-connected state.

Case 4: In a case that the terminal receives, in a connected state from the serving cell, the multicast service that the terminal has joined, and the target cell supports receiving, in a non-connected state, the multicast service that the terminal has joined, the terminal switches from the connected state to a non-connected state after or before handing over from the serving cell to the target cell through a connected state switching process, and receives, in the non-connected state from the target cell, the multicast service that the terminal has joined.

In this embodiment, if the terminal can receive the multicast service only in the connected state in the source cell, for example, in a connected state MRB or DRB manner, the terminal in the connected state can directly handed over, through the connected state switching process by using interaction between the source cell and the target cell and dedicated signaling provided by the target cell, to the target cell first to receive the multicast service in the connected state, and after the handover, the target cell can release the terminal, so that the terminal continues to receive the multicast service in the non-connected state.

Case 5: In a case that the terminal has joined a plurality of multicast services, the terminal determines, based on at least one of priorities of the plurality of multicast services that the terminal has joined, inclination information of the terminal, and indication information of a network-side device, that the terminal is in a connected state or a non-connected state after accessing the target cell, and receives, in the connected state or the non-connected state from the target cell, the plurality of multicast services that the terminal has joined.

In this embodiment, in a case that the terminal has an inclination (for example, a strong power saving inclination), or a network has an indication (for example, an indication sent when network load is excessively heavy), the terminal can also select to receive a part of multicast services of higher priorities from the plurality of multicast services that the terminal has joined, but discard receiving of other low-priority multicast services.

For example, the terminal can select a target cell that supports receiving a high-priority multicast service in a non-connected state, and obtain a configuration by using a SIB and/or an MCCH of the target cell, so as to continue to receive the high-priority multicast service in the non-connected state, and discard another low-priority multicast service that needs to be received in a connected-state. The network-side device can send indication information to indicate the priorities of the plurality of multicast services that the terminal has joined.

Case 6: The network-side device configures a serving cell of the terminal to support receiving, in a non-connected state, all multicast services that the terminal has joined, or configures a serving cell of the terminal to support receiving, in a connected state, all multicast services that the terminal has joined.

During specific implementation, the network-side device can adjust, based on an actual situation, a status of supporting the multicast service by the serving cell of the terminal. For example, when network load is light, the network-side device can configure the serving cell of the terminal to support receiving, in the connected state, all the multicast services that the terminal has joined, and when the network load is excessively heavy, the network-side device can configure the serving cell of the terminal to support receiving, in the non-connected state, all or a part of multicast services that the terminal has joined. In addition, the network-side device can also adjust, based on information such as a quantity of terminals that can receive the multicast service in the non-connected state and that are accessed by controlled cells, the status of supporting the multicast service by the serving cell of the terminal, so that the terminal receives the multicast service in a proper manner.

In Implementation 3, the terminal selects a proper manner (that is, switches to a proper state) based on the target information and with reference to the terminal inclination or the network indication to receive the multicast service, to improve receiving experience of the terminal on a basis of ensuring receiving effects.

### Implementation 4

This implementation describes cases of configuration information of a multicast service.

Case 1: The terminal reads, from SIB signaling and/or MCCH signaling of the target cell, target configuration information of the multicast service that the terminal has joined in the target cell, and receives, from the target cell based on the target configuration information, the multicast service that the terminal has joined.

It can be understood that if there is more than one multicast service that the terminal has joined or is receiving in a non-connected state, the terminal can successfully obtain a new configuration by using a SIB and/or an MCCH after moving to or accessing the target cell, and continue to receive the service in the non-connected state on a prerequisite that all multicast services that the terminal has joined support non-connected-state receiving in the target cell. As long as one multicast service does not support the transmission manner, the terminal needs to perform an RRC state migration to enter a connected state, and the network-side device controls to complete receiving. In this case, the network-side device can configure a connected-state receiving manner for a multicast service that does not support non-connected-state receiving, so that the terminal receives the multicast service. However, for a multicast service that supports connected-state receiving, the terminal can continue to read the SIB and/or MCCH to obtain a configuration and receive the multicast service.

Optionally, that the terminal receives, in a non-connected state from the target cell based on the target configuration information, the multicast service that the terminal has joined includes at least one of the following:

The terminal retains, in a case that original configuration information is the same as the target configuration information, an entity and a parameter that correspond to the original configuration information, and receives, in the non-connected state from the target cell, the multicast service that the terminal has joined, where the original configuration information is configuration information of the multicast service that the terminal has joined in the serving cell.

The terminal performs, in a case that the original configuration information is different from the target configuration information, a reconfiguration based on the target configuration information, and receives, in the non-connected state from the target cell, the multicast service that the terminal has joined.

In this embodiment, if a terminal that is interested in or that has received a multicast service in a source cell stores configuration information (namely, the original configuration information) of the source cell, when obtaining a new multicast service configuration (namely, the target configuration information) from the SIB and/or MCCH of the target cell again, the terminal can compare specific configuration content. If the configurations are the same, current entity running and parameters can be directly kept. If configurations of a parameter are inconsistent (that is, the configuration information is different from the target configuration information), the parameter needs to be reconfigured and a new configuration parameter is applied immediately. If the parameter reconfiguration affects running of the entire entity, for example, relates to a sequence number (Sequence Number, SN) length reconfiguration of a radio link control (Radio Link Control, RLC) protocol or packet data convergence protocol (Packet Data Convergence Protocol, PDCP) entity, a re-establishment (for example, re-establishment) process needs to be performed on the entire entity.

In a possible implementation, that the terminal performs a reconfiguration based on the target configuration information includes at least one of the following:

B-1: The terminal retains a value of an SN status variable or count COUNT status variable of an L2 entity.

B-2: The terminal re-establishes an RLC entity in the L2 entity.

B-3: The terminal retains a value of a COUNT status variable of a PDCP in the L2 entity.

For B-1, when a parameter reconfiguration or entity re-establishment occurs on the L2 (namely, data link) entity (for example, the RLC entity or the PDCP entity), the value of the SN status variable or COUNT (COUNT) status variable needs to be retained, to ensure that data of the source cell and data of the target cell can be received in an order, and a COUNT value of an initial receiving variable in the target cell can be determined, so that an error case like a hyper frame number (Hyper Frame Number, HFN) desynchronization is not caused.

For B-2, because resetting of the SN status variable of the RLC entity does not cause a desynchronization effect, it can be considered to reset (reset) or re-establish (re-establishment) the RLC entity before and after a reselection, and the target cell starts receiving at the initial value of the status variable, or uses the SN status variable of a first received data packet as the initial value of the receiving status variable.

For B-3, COUNT values of the PDCP entity need to be synchronized or continuous. Therefore, the PDCP entity needs to try to keep the COUNT values in a unified order before and after a reselection. Optionally, for an acknowledged mode (Acknowledged Mode, AM) MRB, a COUNT value is maintained. In other words, when the target configuration information is an AM MRB configuration, the terminal retains the value of the COUNT status variable of the PDCP in the L2 entity. For an unacknowledged mode (Unacknowledged Mode, UM) MRB, receiving can be started at the initial value of the status variable, or the SN status variable of a first received data packet is used as the initial value of the receiving status variable, or the initial value of the status variable is calculated. It can be understood that mapping relationships between quality of service (Quality of Service, QoS) flows and DRBs of the source cell and the target cell are preferentially unified. In this way, it can be ensured as much as possible that the COUNT values of the PDCP entity before and after the reselection can be as continuous as possible, to ensure continuous receiving of services of the terminal and obtain synchronized COUNT values in the target cell.

Case 2: The network-side device restores or sends MRB configuration information, where the MRB configuration information is used by the terminal to receive, in a connected state from a target cell after accessing the target cell, a multicast service that the terminal has joined.

In this embodiment, if a cell controlled by the network-side device (namely, the target cell) does not support receiving, in the non-connected state, a multicast service that the terminal is interested in, the target cell can support (or only supports) an MRB configuration of the connected terminal for the multicast service that the terminal is interested in, and perform scheduling in a PTM/G-RNTI multicast manner. In this case, after the terminal restores or enters the connected state, the network-side device restores or configures the MRB and related multicast scheduling configuration information, to complete subsequent connected-state scheduling and transmission.

Case 3: The network-side device sends DRB configuration information, where the DRB configuration information is used by the terminal to receive, in the connected state from the target cell after accessing the target cell, the multicast service that the terminal has joined.

In this embodiment, if the cell controlled by the network-side device (namely, the target cell) does not support receiving, in the non-connected state, the multicast service that the terminal is interested in, the target cell can support (or only supports) a DRB configuration of the connected terminal for the multicast service that the terminal is interested in, and perform scheduling in a point to point (Point To Point, PTP) or C-RNTI unicast manner.

During specific implementation, if the terminal is in an inactive state, context configuration information of the terminal includes not only the MRB and multicast scheduling configuration of the multicast service, but also a DRB configuration of a companion multicast service of the multicast service. In this case, a restoring or switching command of the source cell or the target cell can include only the DRB configuration. If the terminal is in an idle state, during interaction between the source cell and the target cell, or after the terminal accesses the target cell, the target cell configures a DRB for the terminal for service receiving.

In Implementation 4, when a terminal needs to reselect from a source cell to a target cell, if the target cell supports receiving, in a non-connected state, a multicast service that the terminal is interested in, after accessing the target cell, the terminal can obtain a multicast service configuration by using a SIB and/or an MCCH, and correspondingly retain or reset a configuration application of the terminal, an L2 entity, and related parameters, so that the terminal can perform continuous receiving.

### Implementation 5

This implementation describes cases that a neighbor cell includes a cell controlled by a neighbor network-side device (for example, cross-base station).

Case 1: The network-side device obtains multicast service configuration information of the neighbor cell from an interface message of the neighbor network-side device; and configures the multicast service configuration information of the controlled cell as same information as the multicast service configuration information of the neighbor cell.

The first signaling of the network-side device further carries multicast service configuration information of the cell controlled by the network-side device, and multicast service configuration information of one cell is used by the terminal to receive, in the cell, the multicast service that the terminal has joined.

It can be understood that the cell controlled by the network-side device needs to notify, by using a SIB and/or an MCCH, the terminal of a support status of receiving the multicast service in the non-connected state by the neighbor cell. If a cross-network-side device (for example, the next generation node B (the next Generation Node B, gNB)) exists, the information needs to be transmitted by using an interface message between gNBs, and when the information of the neighbor cell changes, surrounding cells need to be notified in time, so that the other cells update neighbor cell information in SIBs and/or MCCHs in time.

Optionally, the multicast service configuration information includes at least one of the following: a mapping relationship between a multicast service QoS flow and an MRB; and configuration information of an L2 entity.

It can be understood that, to enable the non-connected terminal to perform cross-cell continuous receiving, the terminal can learn and successfully obtain the service configuration information of the SIB and/or the MCCH of the target cell. In addition, another important point is that, to ensure successful continuous receiving of an MRB of a multicast service, configuration information of neighbor cells is preferentially consistent.

For example, the mapping relationship between the multicast service QoS flow and the MRB, and the configuration of L2, for example, the RLC or the PDCP, are preferentially consistent in the neighbor cell. In this way, continuity of a COUNT value and HFN synchronization before and after a reselection can be maintained as much as possible, and service continuity experience of the terminal is better. Therefore, neighbor network-side devices can exchange configurations related to receiving a multicast service in a non-connected state, and ensure a consistent configuration as much as possible. For example, the network-side device can configure a mapping relationship between a multicast service QoS flow and a DRB of the controlled cell as a same mapping relationship as a mapping relationship between a multicast service QoS flow and a DRB of the neighbor cell of the cell.

Case 2: The network-side device receives multicast service update information of a cell controlled by a neighbor network-side device, where the multicast service update information represents a change in the information about whether the neighbor cell supports the multicast service. The network-side device updates the target information based on the multicast service update information.

For example, in a cross-base station scenario, information about a neighbor cell that supports receiving a multicast service in a non-connected state (for example, a service list) needs to be exchanged through an interface between base stations. When information about a multicast service of a local cell (namely, a cell controlled by a base station) changes, a neighbor base station needs to be notified in time by using an interface message. The neighbor base station updates neighbor cell information of the neighbor base station based on received latest information, to ensure that a terminal of the neighbor base station can read correct target information.

In Implementation 5, neighbor network-side devices exchange, through an interface, a support status of receiving a multicast service in a non-connected state by a neighbor cell and configuration information of receiving the multicast service in the non-connected state, to ensure cross-cell continuous receiving of the multicast service by the terminal.

According to a second aspect, as shown in FIG. 3, an embodiment of this application provides another neighbor cell information indication method, and the method includes at least the following step:

Step S301: A network-side device sends first signaling that carries target information, where the target information is information about whether a neighbor cell of a cell controlled by the network-side device supports a terminal in receiving a multicast service in a non-connected state.

In a possible implementation, that a network-side device sends first signaling that carries target information includes:

In a case that at least one neighbor cell of the cell controlled by the network-side device supports receiving the multicast service in the non-connected state, the network-side device sends the first signaling that carries the target information.

In a possible implementation, the method further includes:

The network-side device receives multicast service update information of a cell controlled by a neighbor network-side device, where the multicast service update information represents a change in the information about whether the neighbor cell supports the multicast service.

The network-side device updates the target information based on the multicast service update information.

The network-side device sends first signaling that carries updated target information.

In a possible implementation, the method further includes at least one of the following:

The network-side device restores or sends MRB configuration information, where the MRB configuration information is used by the terminal to receive, in a connected state from a target cell after accessing the target cell, a multicast service that the terminal has joined.

The network-side device sends DRB configuration information, where the DRB configuration information is used by the terminal to receive, in the connected state from the target cell after accessing the target cell, the multicast service that the terminal has joined.

In a possible implementation, the first signaling further carries multicast service configuration information of the cell controlled by the network-side device, and multicast service configuration information of one cell is used by the terminal to receive, in the cell, the multicast service that the terminal has joined; and the method further includes:

The network-side device obtains multicast service configuration information of the neighbor cell from an interface message of the neighbor network-side device.

The network-side device configures the multicast service configuration information of the controlled cell as same information as the multicast service configuration information of the neighbor cell.

In a possible implementation, the multicast service configuration information includes at least one of the following:
a mapping relationship between a multicast service QoS flow and an MRB; and
configuration information of an L2 entity.

In a possible implementation, the method further includes:

The network-side device configures a mapping relationship between a multicast service QoS flow and a DRB of the controlled cell as a same mapping relationship as a mapping relationship between a multicast service QoS flow and a DRB of the neighbor cell of the cell.

In a possible implementation, the method further includes:

The network-side device configures a serving cell of the terminal to support receiving, in a non-connected state, all multicast services that the terminal has joined; or
the network-side device configures a serving cell of the terminal to support receiving, in a connected state, all multicast services that the terminal has joined.

In a possible implementation, the method further includes:

The network-side device sends indication information, where the indication information indicates priorities of a plurality of multicast services that the terminal has joined.

The neighbor cell information indication method provided in this embodiment of this application can be performed by a neighbor cell information indication apparatus. In this embodiment of this application, that the neighbor cell information indication apparatus performs the neighbor cell information indication method is used as an example to describe the neighbor cell information indication apparatus provided in this embodiment of this application.

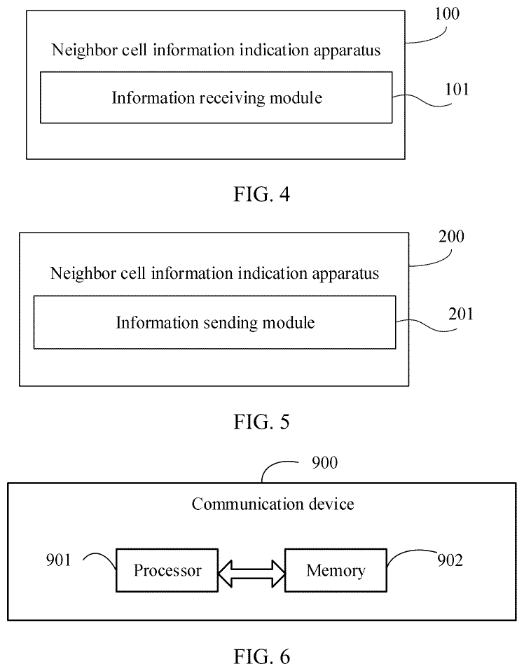

According to a third aspect, an embodiment of this application provides a neighbor cell information indication apparatus. The apparatus can be used in a terminal. As shown in FIG. 4, the neighbor cell information indication apparatus 100 includes:
an information receiving module 101, configured to obtain, from first signaling of a serving cell, target information about whether a neighbor cell supports receiving a multicast service in a non-connected state.

Optionally, the target information includes first information and/or second information.

The first information indicates a neighbor cell that supports receiving a multicast service in a non-connected state.

The second information indicates information about a multicast service that each neighbor cell supports to receive in a non-connected state.

Optionally, the first signaling of the serving cell includes at least one of the following:
SIB signaling of the serving cell, where the SIB signaling carries the first information; and
MCCH signaling of the serving cell, where the MCCH signaling carries the first information and/or the second information.

Optionally, the apparatus further includes:
a first determining module, configured to determine a target cell when a trigger condition of a cell selection and/or reselection mechanism is met; and
a first processing module, configured to: access the target cell, and receive, from the target cell, a multicast service that the terminal has joined.

Optionally, the apparatus further includes:
a second determining module, configured to determine a target cell based on the target information when a trigger condition of a cell selection and/or reselection mechanism is met; and
a second processing module, configured to: access the target cell, and receive, from the target cell, a multicast service that the terminal has joined.

Optionally, the second determining module includes:
a first determining submodule, configured to determine, when the trigger condition of the cell selection and/or reselection mechanism is met, at least one candidate target cell from neighbor cells indicated by the target information; and
a second determining submodule, configured to determine the target cell based on at least one of the following:
determining, as the target cell, one candidate target cell that is in the at least one candidate target cell and that supports receiving, in a non-connected state, the multicast service that the terminal has joined, where in a case that the terminal has joined a plurality of multicast services, that the candidate target cell supports receiving, in the non-connected state, the multicast service that the terminal has joined means that the candidate target cell supports receiving, in the non-connected state, all the multicast services that the terminal has joined;
determining any candidate target cell in the at least one candidate target cell as the target cell in a case that each of the at least one candidate target cell does not support receiving, in a non-connected state, the multicast service that the terminal has joined; and
determining, as the target cell in a case that the at least one candidate target cell partially supports receiving, in a non-connected state, the multicast service that the terminal has joined, one candidate target cell that is in the at least one candidate target cell and that supports a maximum quantity of multicast services that the terminal has joined or supports a multicast service of a highest priority.

That the candidate target cell does not support receiving, in the non-connected state, the multicast service that the terminal has joined means that the candidate target cell does not support receiving, in the non-connected state, all the multicast services that the terminal has joined; and that the candidate target cell partially supports receiving, in the non-connected state, the multicast service that the terminal has joined means that the candidate target cell supports receiving, in the non-connected state, a part of the multicast services that the terminal has joined.

Optionally, the first processing module or the second processing module includes at least one of the following:
a first receiving module, configured to: in a case that the terminal receives, in a non-connected state from the serving cell, the multicast service that the terminal has joined, and the target cell supports receiving, in a non-connected state, the multicast service that the terminal has joined, maintain the non-connected state to access the target cell, where the terminal receives, in the non-connected state from the target cell, the multicast service that the terminal has joined; and
a second receiving module, configured to: in a case that the terminal receives, in a non-connected state from the serving cell, the multicast service that the terminal has joined, and the target cell does not support receiving, in a non-connected state, the multicast service that the terminal has joined, switch from the non-connected state to a connected state, and access the target cell, where the terminal receives, in the connected state from the target cell, the multicast service that the terminal has joined, and the terminal switches from the non-connected state to the connected state before or after accessing the target cell.

Optionally, the first processing module or the second processing module includes at least one of the following:
a third receiving module, configured to: in a case that the terminal receives, in a connected state from the serving cell, the multicast service that the terminal has joined, and the target cell does not support receiving, in a non-connected state, the multicast service that the terminal has joined, maintain the connected state, and receive, from the target cell, the multicast service that the terminal has joined; and
a fourth receiving module, configured to: in a case that the terminal receives, in a connected state from the serving cell, the multicast service that the terminal has joined, and the target cell supports receiving, in a non-connected state, the multicast service that the terminal has joined, switch from the connected state to a non-connected state after or before handing over from the serving cell to the target cell through a connected state switching process, and receive, in the non-connected state from the target cell, the multicast service that the terminal has joined.

Optionally, in a case that the terminal has joined a plurality of multicast services, the first processing module or the second processing module includes:
a status determining module, configured to determine, based on at least one of priorities of the plurality of multicast services that the terminal has joined, inclination information of the terminal, and indication information of a network-side device, that the terminal is in a connected state or a non-connected state after accessing the target cell; and
a fifth receiving module, configured to receive, in the connected state or the non-connected state from the target cell, the plurality of multicast services that the terminal has joined.

Optionally, the first processing module or the second processing module includes:
a first reading module, configured to read, from SIB signaling and/or MCCH signaling of the target cell, target configuration information of the multicast service that the terminal has joined in the target cell; and
a sixth receiving module, configured to receive, from the target cell based on the target configuration information, the multicast service that the terminal has joined.

Optionally, the sixth receiving module includes at least one of the following:
a first receiving submodule, configured to: in a case that original configuration information is the same as the target configuration information, retain an entity and a parameter that correspond to the original configuration information, and receive, in the non-connected state from the target cell, the multicast service that the terminal has joined, where the original configuration information is configuration information of the multicast service that the terminal has joined in the serving cell; and
a second receiving submodule, configured to: in a case that the original configuration information is different from the target configuration information, perform a reconfiguration based on the target configuration information, and receive, in the non-connected state from the target cell, the multicast service that the terminal has joined.

Optionally, the second receiving submodule includes at least one of the following:
a first reconfiguration module, configured to retain a value of an SN status variable or COUNT status variable of an L2 entity;
a second reconfiguration module, configured to re-establish an RLC entity in the L2 entity; and
a third reconfiguration module, configured to retain a value of a COUNT status variable of a PDCP in the L2 entity.

Optionally, the first reconfiguration module includes:
a reconfiguration submodule, configured to: in a case that the target configuration information is an AM MRB configuration, retain the value of the COUNT status variable of the PDCP in the L2 entity.

Optionally, the first information is a first cell ID list or a first cell index list.

The first cell ID list includes IDs that are carried in the first signaling and that indicate neighbor cells that support receiving at least one multicast service in a non-connected state.

The first cell index list is position or sorting information of neighbor cells that are in a cell ID list carried in other signaling and that support receiving at least one multicast service in a non-connected state.

Optionally, the second information is a second cell ID list or a second cell index list corresponding to each multicast service.

The second cell ID list corresponding to each multicast service includes IDs of neighbor cells that support receiving the multicast service in a non-connected state.

The second cell index list corresponding to each multicast service is position or sorting information of neighbor cells that are in a cell ID list carried in the first signaling or other signaling and that support receiving the multicast service in a non-connected state.

Optionally, the apparatus further includes:
a signaling receiving module, configured to receive changed first signaling of the serving cell, where the changed first signaling of the serving cell is generated in a case that the information about whether the neighbor cell supports receiving the multicast service in the non-connected state changes; and
an information re-obtaining module, configured to re-obtain, from the changed first signaling of the serving cell, the target information about whether the neighbor cell supports receiving the multicast service in the non-connected state.

The neighbor cell information indication apparatus provided in this embodiment of this application can implement processes implemented in the neighbor cell information indication method embodiment according to the first aspect, and achieve a same technical effect. To avoid repetition, details are not described herein again.

According to a fourth aspect, an embodiment of this application provides another neighbor cell information indication apparatus, and the apparatus can be used in a network-side device. As shown in FIG. 5, the neighbor cell information indication apparatus 200 includes:
an information sending module 201, configured to send first signaling that carries target information, where the target information is information about whether a neighbor cell of a cell controlled by the network-side device supports a terminal in receiving a multicast service in a non-connected state.

Optionally, the information sending module 201 includes:
a first sending submodule, configured to send, in a case that at least one neighbor cell of the cell controlled by the network-side device supports receiving the multicast service in the non-connected state, the first signaling that carries the target information.

Optionally, the apparatus further includes:
a first processing module, configured to receive multicast service update information of a cell controlled by a neighbor network-side device, where the multicast service update information represents a change in the information about whether the neighbor cell supports the multicast service;
a second processing module, configured to update the target information based on the multicast service update information; and
a third processing module, configured to send first signaling that carries updated target information.

Optionally, the apparatus further includes at least one of the following:
a fourth processing module, configured to restore or send MRB configuration information, where the MRB configuration information is used by the terminal to receive, in a connected state from a target cell after accessing the target cell, a multicast service that the terminal has joined; and
a fifth processing module, configured to send DRB configuration information, where the DRB configuration information is used by the terminal to receive, in the connected state from the target cell after accessing the target cell, the multicast service that the terminal has joined.

Optionally, the first signaling further carries multicast service configuration information of the cell controlled by the network-side device, and multicast service configuration information of one cell is used by the terminal to receive, in the cell, the multicast service that the terminal has joined; and the apparatus further includes:
a sixth processing module, configured to obtain multicast service configuration information of the neighbor cell from an interface message of the neighbor network-side device; and
a seventh processing module, configured to configure the multicast service configuration information of the controlled cell as same information as the multicast service configuration information of the neighbor cell.

Optionally, the multicast service configuration information includes at least one of the following:
a mapping relationship between a multicast service QoS flow and an MRB; and
configuration information of an L2 entity.

Optionally, the apparatus further includes:
a relationship configuration module, configured to configure a mapping relationship between a multicast service QoS flow and a DRB of the controlled cell as a same mapping relationship as a mapping relationship between a multicast service QoS flow and a DRB of the neighbor cell of the cell.

Optionally, the apparatus further includes:
an eighth processing module, configured to configure a serving cell of the terminal to support receiving, in a non-connected state, all multicast services that the terminal has joined; or configured to configure a serving cell of the terminal to support receiving, in a connected state, all multicast services that the terminal has joined.

Optionally, the apparatus further includes:
a ninth processing module, configured to send indication information, where the indication information indicates priorities of a plurality of multicast services that the terminal has joined.

The neighbor cell information indication apparatus provided in this embodiment of this application can implement processes implemented in the neighbor cell information indication method embodiment according to the second aspect, and achieve a same technical effect. To avoid repetition, details are not described herein again.

Optionally, as shown in FIG. 6, an embodiment of this application further provides a communication device 900, including a processor 901 and a memory 902. The memory 902 stores a program or instructions that can be run on the processor 901. For example, when the communication device 900 is a terminal, the program or instructions are executed by the processor 901 to implement the step of the neighbor cell information indication method embodiment according to the first aspect, and a same technical effect can be achieved. When the communication device 900 is a network-side device, the program or instructions are executed by the processor 901 to implement the step of the neighbor cell information indication method embodiment according to the second aspect, and a same technical effect can be achieved. To avoid repetition, details are not described herein again.

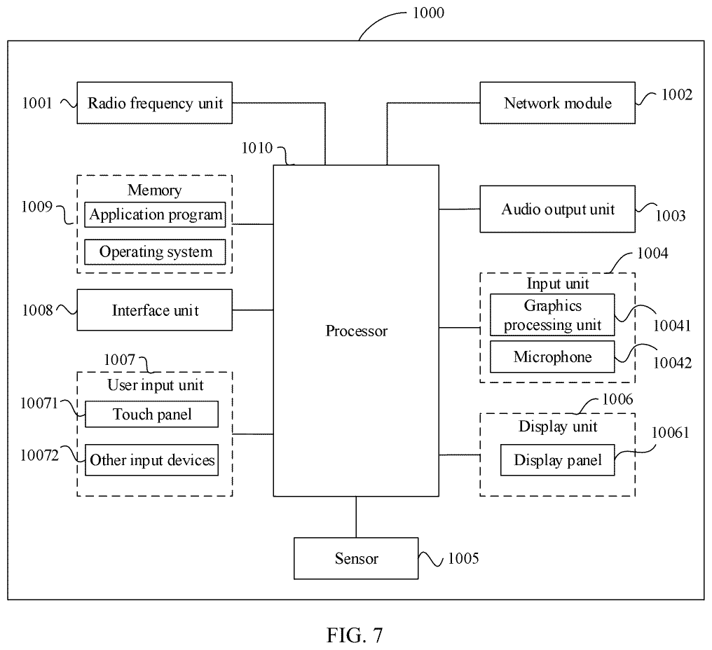

FIG. 7 is a schematic diagram of a hardware structure of a terminal according to an embodiment of this application.

The terminal 1000 is configured to perform the step of the neighbor cell information indication method embodiment according to the first aspect, and can achieve a same technical effect. The terminal 1000 includes but is not limited to at least a part of components in a radio frequency unit 1001, a network module 1002, an audio output unit 1003, an input unit 1004, a sensor 1005, a display unit 1006, a user input unit 1007, an interface unit 1008, a memory 1009, a processor 1010, and the like.

A person skilled in the art can understand that the terminal 1000 can further include a power supply (for example, a battery) that supplies power to each component. The power supply can be logically connected to the processor 1010 through a power management system, to implement functions such as charging management, discharging management, and power consumption management through the power management system. The structure of the terminal shown in FIG. 7 does not constitute a limitation on the terminal. The terminal can include more or fewer components than those shown in the figure, or combine some components, or have different component arrangements. Details are not described herein again.

It should be understood that in this embodiment of this application, the input unit 1004

can include a graphics processing unit (Graphics Processing Unit, GPU) 10041 and a microphone 10042. The graphics processing unit 10041 processes image data of a still picture or a video obtained by an image capture apparatus (for example, a camera) in a video capture mode or an image capture mode. The display unit 1006 can include a display panel 10061, and the display panel 10061 can be configured in a form of a liquid crystal display, an organic light-emitting diode, or the like. The user input unit 1007 includes at least one of a touch panel 10071 and other input devices 10072. The touch panel 10071 is also referred to as a touchscreen. The touch panel 10071 can include two parts: a touch detection apparatus and a touch controller. The other input devices 10072 can include but are not limited to a physical keyboard, a function key (such as a volume control key or an on/off key), a trackball, a mouse, and a joystick. Details are not described herein again.

In this embodiment of this application, after receiving downlink data from a network-side device, the radio frequency unit 1001 can transmit the downlink data to the processor 1010 for processing. In addition, the radio frequency unit 1001 can send uplink data to the network-side device. Generally, the radio frequency unit 1001 includes but is not limited to an antenna, an amplifier, a transceiver, a coupler, a low-noise amplifier, a duplexer, and the like.

The memory 1009 can be configured to store a software program or instructions and various types of data. The memory 1009 can mainly include a first storage area for storing a program or instructions and a second storage area for storing data. The first storage area can store an operating system, an application program or instructions required by at least one function (for example, a sound play function or an image play function), and the like. In addition, the memory 1009 can include a volatile memory or a nonvolatile memory, or the memory 1009 can include both a volatile memory and a nonvolatile memory. The nonvolatile memory can be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory can be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1009 in this embodiment of this application includes but is not limited to these memories and any other suitable type of memory.

The processor 1010 can include one or at least two processing units. Optionally, the processor 1010 integrates an application processor and a modem processor. The application processor mainly processes operations related to an operating system, a user interface, an application program, and the like. The modem processor, for example, a baseband processor, mainly processes a wireless communication signal. It can be understood that, the foregoing modem processor may not be integrated into the processor 1010.

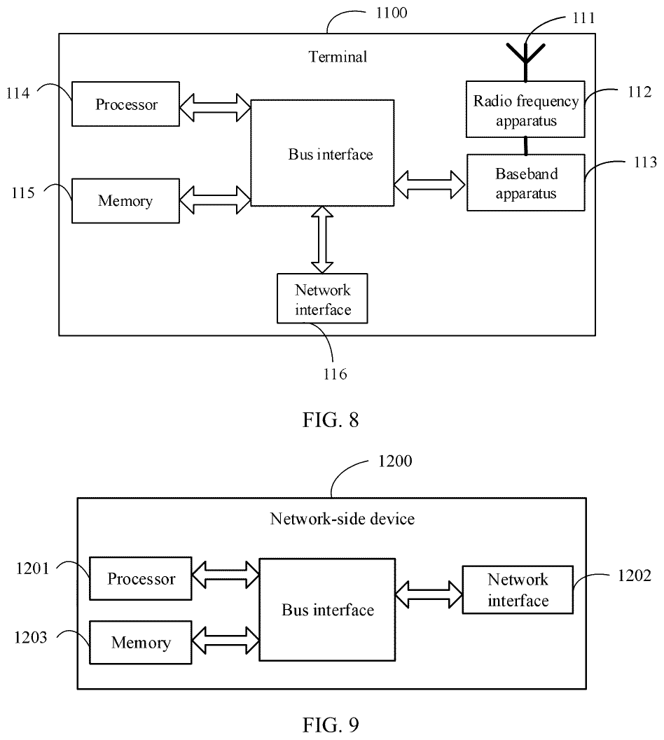

An embodiment of this application further provides a terminal. As shown in FIG. 8, the terminal 1100 includes an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information through the antenna 111, and sends the received information to the baseband apparatus 113 for processing. In a downlink direction, the baseband apparatus 113 processes to-be-sent information, and sends processed information to the radio frequency apparatus 112. After processing the received information, the radio frequency apparatus 112 sends processed information through the antenna 11.

In the foregoing embodiment, the neighbor cell information indication method performed by the terminal can be implemented in the baseband apparatus 113. The baseband apparatus 113 includes a baseband processor.

For example, the baseband apparatus 113 can include at least one baseband board. At least two chips are disposed on the baseband board. As shown in FIG. 8, one of the chips is, for example, the baseband processor, and is connected to the memory 115 through a bus interface, to invoke a program in the memory 115 to perform the operation of the network-side device shown in the foregoing neighbor cell information indication method embodiment according to the first aspect.

The terminal can further include a network interface 116, and the interface is, for example, a common public radio interface (common public radio interface, CPRI).

Specifically, the terminal 1100 in this embodiment of this application further includes instructions or a program stored in the memory 115 and capable of running on the processor 114. The processor 114 invokes the instructions or the program in the memory 115 to perform the neighbor cell information indication method according to the first aspect, and achieve a same technical effect. To avoid repetition, details are not described herein again.

An embodiment of this application further provides a network-side device. As shown in FIG. 9, the network-side device 1200 includes a processor 1201, a network interface 1202, and a memory 1203. The network interface 1202 is, for example, a common public radio interface (common public radio interface, CPRI).

Specifically, the network-side device 1200 in this embodiment of this application further includes instructions or a program stored in the memory 1203 and capable of running on the processor 1201. The processor 1201 invokes the instructions or the program in the memory 1203 to perform the neighbor cell information indication method according to the second aspect, and achieve a same technical effect. To avoid repetition, details are not described herein again.

An embodiment of this application further provides a readable storage medium. The readable storage medium stores a program or instructions. When the program or instructions are executed by a processor, processes in the foregoing neighbor cell information indication method embodiment are implemented, and a same technical effect can be achieved. To avoid repetition, details are not described herein again.

The processor is a processor in the terminal in the foregoing embodiment. The readable storage medium includes a computer-readable storage medium, for example, a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or instructions, to implement processes in the foregoing neighbor cell information indication method embodiment, and a same technical effect can be achieved. To avoid repetition, details are not described herein again.

It should be understood that, the chip mentioned in this embodiment of this application can also be referred to as a system-level chip, a system chip, a chip system, a system on chip, or the like.

An embodiment of this application further provides a computer program/program product. The computer program/program product is stored in a storage medium. The computer program/program product is executed by at least one processor to implement processes in the foregoing neighbor cell information indication method embodiment, and a same technical effect can be achieved. To avoid repetition, details are not described herein again.

An embodiment of this application further provides a neighbor cell information indication system, including a network-side device and a terminal. The terminal is configured to perform the step of the neighbor cell information indication method according to the first aspect, and the network-side device is configured to perform the step of the neighbor cell information indication method according to the second aspect.

It should be noted that in this specification, the term “include”, “contain”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. Moreover, it should be noted that the scope of the method and apparatus in embodiments of this application is not limited to executing the functions in the shown or discussed order, but can include executing the functions in a substantially concurrent manner or in a reverse order depending on the related functions. For example, the described method can be performed in an order different from that described, and various steps can be further added, omitted, or combined. In addition, features described with reference to some examples can be combined in other examples.

According to the foregoing descriptions of the implementations, a person skilled in the art can clearly understand that the method in the foregoing embodiments can be implemented by software and a necessary general-purpose hardware platform, or certainly can be implemented by hardware. However, in many cases, the former is a better implementation. Based on such an understanding, the technical solutions of this application essentially or the part contributing to the prior art can be implemented in a form of a computer software product. The computer software product is stored in a storage medium (for example, a ROM/RAM, a magnetic disk, or an optical disc), and includes several instructions for instructing a terminal (which can be a mobile phone, a computer, a server, an air conditioner, a network device, or the like) to perform the methods described in embodiments of this application.

The foregoing describes embodiments of this application with reference to the accompanying drawings. However, this application is not limited to the foregoing specific implementations. The foregoing specific implementations are merely illustrative rather than restrictive. Inspired by this application, a person of ordinary skill in the art can develop many other manners without departing from principles of this application and the protection scope of the claims, and all such manners fall within the protection scope of this application.

1. A neighbor cell information indication method, comprising:
obtaining, by a terminal from first signaling of a serving cell, target information about whether a neighbor cell supports receiving a multicast service in a non-connected state.

2. The method according to claim 1, wherein the target information comprises first information and/or second information;
the first information indicates a neighbor cell that supports receiving a multicast service in a non-connected state; and
the second information indicates information about a multicast service that each neighbor cell supports to receive in a non-connected state.

3. The method according to claim 2, wherein the first signaling of the serving cell comprises at least one of the following:
system information block (SIB) signaling of the serving cell, wherein the SIB signaling carries the first information; and
multicast/broadcast service control channel (MCCH) signaling of the serving cell, wherein the MCCH signaling carries the first information and/or the second information.

4. The method according to claim 1, wherein the method further comprises:
determining, by the terminal, a target cell when a trigger condition of a cell selection and/or reselection mechanism is met; and
accessing, by the terminal, the target cell, and receiving, from the target cell, a multicast service that the terminal has joined.

5. The method according to claim 4, wherein the receiving, by the terminal from the target cell, a multicast service that the terminal has joined comprises at least one of the following:
in a case that the terminal receives, in a non-connected state from the serving cell, the multicast service that the terminal has joined, and the target cell supports receiving, in a non-connected state, the multicast service that the terminal has joined, maintaining, by the terminal, the non-connected state to access the target cell, and receiving, by the terminal in the non-connected state from the target cell, the multicast service that the terminal has joined; or
in a case that the terminal receives, in a non-connected state from the serving cell, the multicast service that the terminal has joined, and the target cell does not support receiving, in a non-connected state, the multicast service that the terminal has joined, switching, by the terminal, from the non-connected state to a connected state, and accessing the target cell, and receiving, by the terminal in the connected state from the target cell, the multicast service that the terminal has joined, wherein the terminal switches from the non-connected state to the connected state before or after accessing the target cell.

6. The method according to claim 4, wherein the receiving, by the terminal from the target cell, a multicast service that the terminal has joined comprises at least one of the following:
in a case that the terminal receives, in a connected state from the serving cell, the multicast service that the terminal has joined, and the target cell does not support receiving, in a non-connected state, the multicast service that the terminal has joined, maintaining, by the terminal, the connected state, and receiving, from the target cell, the multicast service that the terminal has joined; or
in a case that the terminal receives, in a connected state from the serving cell, the multicast service that the terminal has joined, and the target cell supports receiving, in a non-connected state, the multicast service that the terminal has joined, switching, by the terminal, from the connected state to a non-connected state after or before handing over from the serving cell to the target cell through a connected state switching process, and receiving, in the non-connected state from the target cell, the multicast service that the terminal has joined.

7. The method according to claim 4, wherein in a case that the terminal has joined a plurality of multicast services, the receiving, by the terminal from the target cell, a multicast service that the terminal has joined comprises:
determining, by the terminal based on at least one of priorities of the plurality of multicast services that the terminal has joined, inclination information of the terminal, and indication information of a network-side device, that the terminal is in a connected state or a non-connected state after accessing the target cell; and
receiving, by the terminal in the connected state or the non-connected state from the target cell, the plurality of multicast services that the terminal has joined.

8. The method according to claim 4, wherein the receiving, by the terminal from the target cell, a multicast service that the terminal has joined comprises:
reading, by the terminal from SIB signaling and/or MCCH signaling of the target cell, target configuration information of the multicast service that the terminal has joined in the target cell; and
receiving, by the terminal from the target cell based on the target configuration information, the multicast service that the terminal has joined,
wherein the receiving, by the terminal in a non-connected state from the target cell based on the target configuration information, the multicast service that the terminal has joined comprises at least one of the following:
retaining, by the terminal in a case that original configuration information is the same as the target configuration information, an entity and a parameter that correspond to the original configuration information, and receiving, in the non-connected state from the target cell, the multicast service that the terminal has joined, wherein the original configuration information is configuration information of the multicast service that the terminal has joined in the serving cell; and
performing, by the terminal in a case that the original configuration information is different from the target configuration information, a reconfiguration based on the target configuration information, and receiving, in the non-connected state from the target cell, the multicast service that the terminal has joined.

9. The method according to claim 2, wherein the first information is a first cell identity (ID) list or a first cell index list;
the first cell ID list comprises IDs that are carried in the first signaling and that indicate neighbor cells that support receiving at least one multicast service in a non-connected state; and
the first cell index list is position or sorting information of neighbor cells that are in a cell ID list carried in other signaling and that support receiving at least one multicast service in a non-connected state.

10. A neighbor cell information indication method, wherein the method comprises:
sending, by a network-side device, first signaling that carries target information, wherein the target information is information about whether a neighbor cell of a cell controlled by the network-side device supports a terminal in receiving a multicast service in a non-connected state.

11. The method according to claim 10, wherein the target information comprises first information and/or second information;
the first information indicates a neighbor cell that supports receiving a multicast service in a non-connected state; and
the second information indicates information about a multicast service that each neighbor cell supports to receive in a non-connected state.

12. The method according to claim 11, wherein the first signaling is signaling of a serving cell of the terminal and comprises at least one of the following:
system information block (SIB) signaling of the serving cell, wherein the SIB signaling carries the first information; and
multicast/broadcast service control channel (MCCH) signaling of the serving cell, wherein the MCCH signaling carries the first information and/or the second information.

13. The method according to claim 10, wherein the sending, by a network-side device, first signaling that carries target information comprises:
in a case that at least one neighbor cell of the cell controlled by the network-side device supports receiving the multicast service in the non-connected state, sending, by the network-side device, the first signaling that carries the target information.

14. The method according to claim 10, wherein the method further comprises at least one of the following:
receiving, by the network-side device, multicast service update information of a cell controlled by a neighbor network-side device, wherein the multicast service update information represents a change in the information about whether the neighbor cell supports the multicast service; updating, by the network-side device, the target information based on the multicast service update information; and sending, by the network-side device, first signaling that carries updated target information;
restoring or sending, by the network-side device, multicast/broadcast service radio bearer (MRB) configuration information, wherein the MRB configuration information is used by the terminal to receive, in a connected state from a target cell after accessing the target cell, a multicast service that the terminal has joined; and
sending, by the network-side device, data radio bearer (DRB) configuration information, wherein the DRB configuration information is used by the terminal to receive, in the connected state from the target cell after accessing the target cell, the multicast service that the terminal has joined.

15. The method according to claim 10, wherein the first signaling further carries multicast service configuration information of the cell controlled by the network-side device, and multicast service configuration information of one cell is used by the terminal to receive, in the cell, the multicast service that the terminal has joined; and the method further comprises:
obtaining, by the network-side device, multicast service configuration information of the neighbor cell from an interface message of the neighbor network-side device; and
configuring, by the network-side device, the multicast service configuration information of the controlled cell as same information as the multicast service configuration information of the neighbor cell,
wherein the multicast service configuration information comprises at least one of the following:
a mapping relationship between a multicast service quality of service (QoS) flow and an MRB; and
configuration information of an L2 entity.

16. The method according to claim 10, wherein the terminal is configured to:
determine a target cell when a trigger condition of a cell selection and/or reselection mechanism is met; and
access the target cell, and receive, from the target cell, a multicast service that the terminal has joined.

17. The method according to claim 16, wherein the terminal is configured to receive, from the target cell, the multicast service that the terminal has joined by at least one of the following:
in a case that the terminal receives, in a non-connected state from the serving cell, the multicast service that the terminal has joined, and the target cell supports receiving, in a non-connected state, the multicast service that the terminal has joined, maintaining, by the terminal, the non-connected state to access the target cell, and receiving, by the terminal in the non-connected state from the target cell, the multicast service that the terminal has joined; or
in a case that the terminal receives, in a non-connected state from the serving cell, the multicast service that the terminal has joined, and the target cell does not support receiving, in a non-connected state, the multicast service that the terminal has joined, switching, by the terminal, from the non-connected state to a connected state, and accessing the target cell, and receiving, by the terminal in the connected state from the target cell, the multicast service that the terminal has joined, wherein the terminal switches from the non-connected state to the connected state before or after accessing the target cell.

18. The method according to claim 11, wherein the first information is a first cell identity (ID) list or a first cell index list;
the first cell ID list comprises IDs that are carried in the first signaling and that indicate neighbor cells that support receiving at least one multicast service in a non-connected state; and
the first cell index list is position or sorting information of neighbor cells that are in a cell ID list carried in other signaling and that support receiving at least one multicast service in a non-connected state.

19. A terminal, comprising a processor and a memory, wherein the memory stores a program or instructions capable of running on the processor, and the program or instructions, when executed by the processor, implements the step of
obtaining, by the terminal from first signaling of a serving cell, target information about whether a neighbor cell supports receiving a multicast service in a non-connected state.

20. A network-side device, comprising a processor and a memory, wherein the memory stores a program or instructions capable of running on the processor, and when the program or instructions are executed by the processor, the steps of the neighbor cell information indication method according to claim 10 are implemented.
